(19) United States
(12) Patent Application Publication
(10) Pub. No.: US 2010/0058308 A1
(43) Pub. Date: Mar. 4, 2010

(54) CENTRAL PROVIDER AND SATELLITE PROVIDER UPDATE AND DIAGNOSIS INTEGRATION TOOL

(75) Inventors: Paul Christopher Demshur, Raleigh, NC (US); Siaka Bamba Kromah, Creedmoor, NC (US); Brian DeAlt Oakley, Varina, NC (US); Kenneth Robert Pressey, Raleigh, NC (US); Eric Allen Stegner, Durham, NC (US); Kimberly Irene Stegner, Durham, NC (US)

Correspondence Address: McGinn Intellectual Property Law Group, PLLC, 8321 Old Courthouse Road, Suite 200, Vienna, VA, 22182-3817, US

(73) Assignee: International Business Machines Corporation, Armonk, NY (US)

(21) Appl. No.: 12/201,886

(22) Filed: Aug. 29, 2008

(51) Int. Cl. G06F 9/44; G06F 11/07

(52) U.S. Cl. 717/168; 714/25; 714/E11.025

(57) ABSTRACT

The present invention generally relates to computer systems and methods of integrating a central system and a satellite system for automatically updating software and providing diagnostics for a product system to be shipped to an end customer.

### BACKGROUND OF THE INVENTION

1. Field of the Invention

The present invention generally relates to computer systems and methods of integrating a central system and a satellite system for automatically updating software and providing diagnostics for a product system to be shipped to an end customer.

2. Description of the Related Art

A central provider provides the bulk of the hardware and software for computer product systems to satellite providers. These satellite providers then place additional hardware and software for more specific niche operations, which the satellite providers specialize in, before sending the product systems to the ultimate customers.

One problem that often occurs, however, is that the basic hardware and software for the computer product systems, provided by the central provider to the satellite provider, often sits for long periods of time on the shelves of the satellite provider until the satellite provider finds a customer for that particular product system. During this storage, the original software installed on the product system may be obsolete and a software update may be required.

Conventional methods of updating the software, however, consists of the satellite provider being aware that a software update is available, a person at the satellite provider downloading the software update from the central provider to a satellite server, and then manually uploading the software update to the product system from the satellite server before shipping it to the customer. Accordingly, because the process is time consuming and requires scarce human resources, the updating of the software prior to shipping is spotty at best.

### SUMMARY OF THE INVENTION

In view of the foregoing and other exemplary problems, drawbacks, and disadvantages of the conventional methods and structures, an exemplary feature of the present invention is to provide a method of integrating a central system and a satellite system for automatically updating software and providing diagnostics for a product system to be shipped to an end customer.

Another exemplary feature of the present invention is a system for integrating a central system and a satellite system for automatically updating software and providing diagnostics for a product system to be shipped to an end customer.

An exemplary embodiment of the present invention includes a method of integrating a central system and a satellite system for automatically updating software and providing diagnostics for a product system to be shipped to an end customer. The method includes providing the central system including a central server and a tracking server at a central provider location, providing a satellite system including a satellite server and a local connection at a satellite provider location different from the central provider location, connecting a product system to the local connection, uploading software updates from the satellite server to the product system, performing a test boot-up of the product system, running a system diagnostic if there is a problem with the test boot-up of the product system, conducting a system repair based on results of the system diagnostic, generating an automated repair ticket concerning the problem if the system repair is unsuccessful, reporting the automated repair ticket to the central server, deploying onsite support to the satellite provider location based on the automated ticket, generating an automated replacement order if the onsite support cannot resolve the problem, sending the automated replacement order to the central server, shipping a replacement product system to the satellite provider location based on the automated replacement order, creating a log on the satellite server of the software updates, results of the system diagnostic, results of the system repair for the product system, the automatic repair ticket, and the automated replacement order, creating a copy of the log on the tracking server, and shipping the product system to the end customer.

An exemplary embodiment of the present invention includes a system for integrating a central system and a satellite system for automatically updating software and providing diagnostics for a product system to be shipped to an end customer. The system includes a central system including a central server and a tracking server at a central provider location and a satellite system including a satellite server and a local connection at a satellite provider location different from the central provider location. The system also includes a product system connected to the local connection.

The satellite server includes software for uploading software updates from the satellite server to the product system, performing a test boot-up of the product system, running a system diagnostic if there is a problem with the test boot-up of the product system, conducting a system repair based on results of the system diagnostic, generating an automated repair ticket concerning the problem if the system repair is unsuccessful, reporting the automated repair ticket to the central server, generating an automated replacement order if the onsite support cannot resolve the problem, sending the automated replacement order to the central server, creating a log on the satellite server of the software updates, results of the system diagnostic, results of the system repair for the product system, the automatic repair ticket, and the automated replacement order, and shipping the product system to the end customer.

The central server includes software for uploading software updates to the satellite server, receiving the automated repair ticket, deploying onsite support to the satellite provider location based on the automated repair ticket, shipping a replacement product system to the satellite provider location based on the automated replacement order, and creating a copy of the log on the tracking server.

### BRIEF DESCRIPTION OF THE DRAWINGS

The foregoing and other exemplary purposes, aspects and advantages will be better understood from the following detailed description of an exemplary embodiment of the invention with reference to the drawings, in which:

FIG. 1 illustrates an exemplary system for integrating a central provider and a satellite provider to update and diagnose product systems;

FIG. 2 illustrates an exemplary method of integrating a central provider and a satellite provider to update and diagnose product systems; and

FIG. 3 illustrates an exemplary method of integrating a central provider and a satellite provider to update and diagnose product systems.

### DETAILED DESCRIPTION OF EXEMPLARY EMBODIMENTS OF THE INVENTION

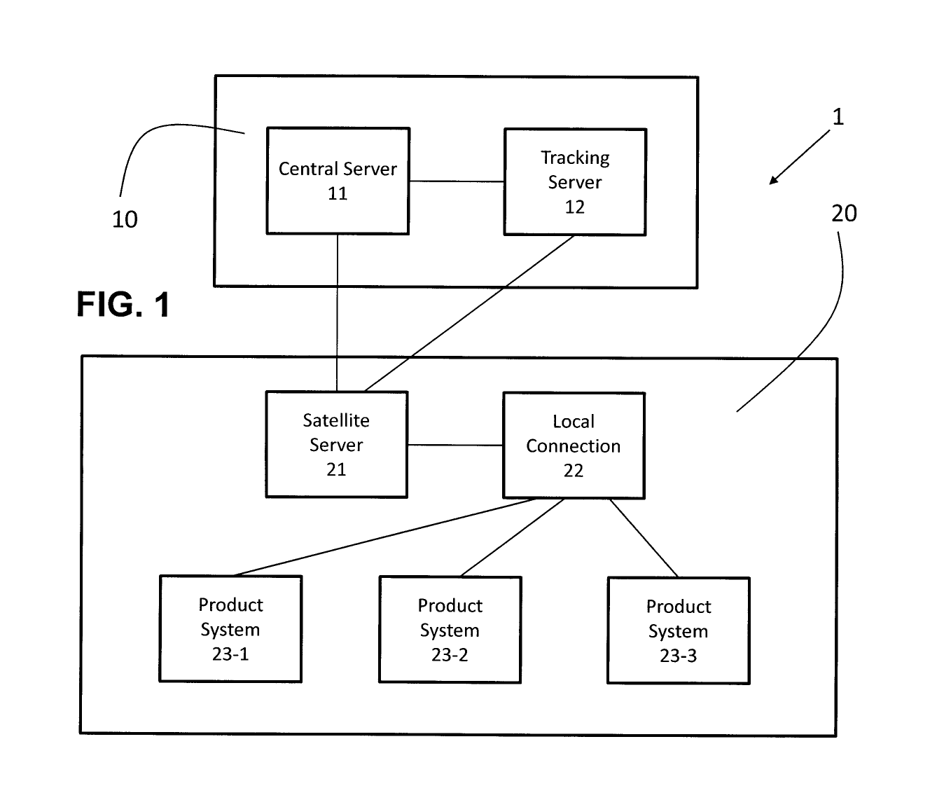

FIG. 1 discloses an exemplary embodiment of system I according to an aspect of the present invention. System I may include central system 10 and satellite system 20.

Central system 10 may include central server 11 and tracking server 12. Central system 10 may be located at a central manufacturing and software development site, for example, where software and software updates for any product system may be directly uploaded by the software developers to central server 11. Tracking server 12 may be located at the same facility as central server 11. Tracking server 12 may be connected to central server 11 and satellite server 21.

Satellite system 20 may include satellite server 21, local connection 22, and a plurality of product systems 23-1, 23-2, 23-3. Satellite server 21 may be connected to and exchange data with central system 10 via central server 11 and tracking server 12. For example, satellite server 21 may download software updates from central server 11 and provide reports concerning software uploaded to products systems 23-1, 23-2, 23-3 to tracking server 12. Products systems 23-1, 23-2, 23-3 may be connected to satellite server 21 via a local connection 22, for example, a local area network. Product systems 23-1, 23-2, 23-3 may download software updates from and upload system update information to satellite server 21 via local connection 22. Product systems 23-1, 23-2, 23-3 may be systems provided by the central provider to the satellite provider. The satellite provider may then make alterations to product systems 23-1, 23-2, 23-3 before sending them to the end customer.

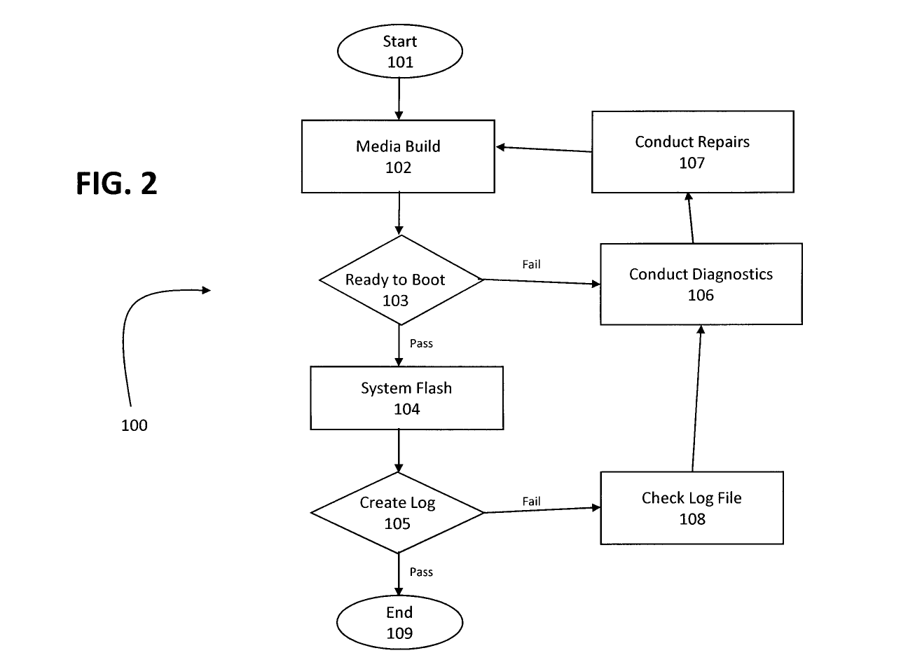

FIG. 2 discloses an exemplary method 100 according to an aspect of the present invention which may be executed within satellite system 20. The method begins at Step 101 by connecting at least one of product systems 23-1, 23-2, 23-3 to local connection 22 so that data may be exchanged between product systems 23-1, 23-2, 23-3 and satellite server 21. At Step 102, product systems 23-1, 23-2, 23-3 conduct a MEDIA BUILD where items such as software updates on satellite server 21 are uploaded to product systems 23-1, 23-2, 23-3.

Once the software updates have been uploaded, product systems 23-1, 23-2, 23-3 are then booted so as to ensure that product systems 23-1, 23-2, 23-3 properly operate. If the initial boot-up of product systems 23-1, 23-2, 23-3 are successful, product systems 23-1, 23-2, 23-3 proceed to Step 104 and conduct a SYSTEM FLASH, and then performs the step of CREATE LOG at Step 105 which may include recording data concerning each of product systems 23-1, 23-2, 23-3.

If the initial boot-up is unsuccessful at Step 103, CONDUCT DIAGNOSTICS is performed at Step 106 to ascertain the problems. The CONDUCT DIAGNOSTICS may be conducted using software on any combination of satellite server 21 and central server 11. Step 106 may also be performed by bringing in a repair specialist to diagnose the problem. Once the problem has been identified, CONDUCT REPAIRS is done at Step 107, at which point the system returns to Step 102 and the MEDIA BUILD is again performed to update all software on product systems 23-1, 23-2, 23-3.

If there is an error in Step 105 at CREATE LOG, satellite server 21 searches both its own logs, as well as the logs in central system 10 for the particular product system 23-1, 23-2, 23-3, to determine whether there have been any problems in the past which may account for the current problems. Once that information has been gathered, a CONDUCT DIAGNOSTICS is performed at Step 106 and the process proceeds from that point as set forth above.

Once CREATE LOG at Step 105 has been successfully completed, product systems 23-1, 23-2, 23-3 are unplugged from local connection 22 and shipped to the end customer at Step 109.

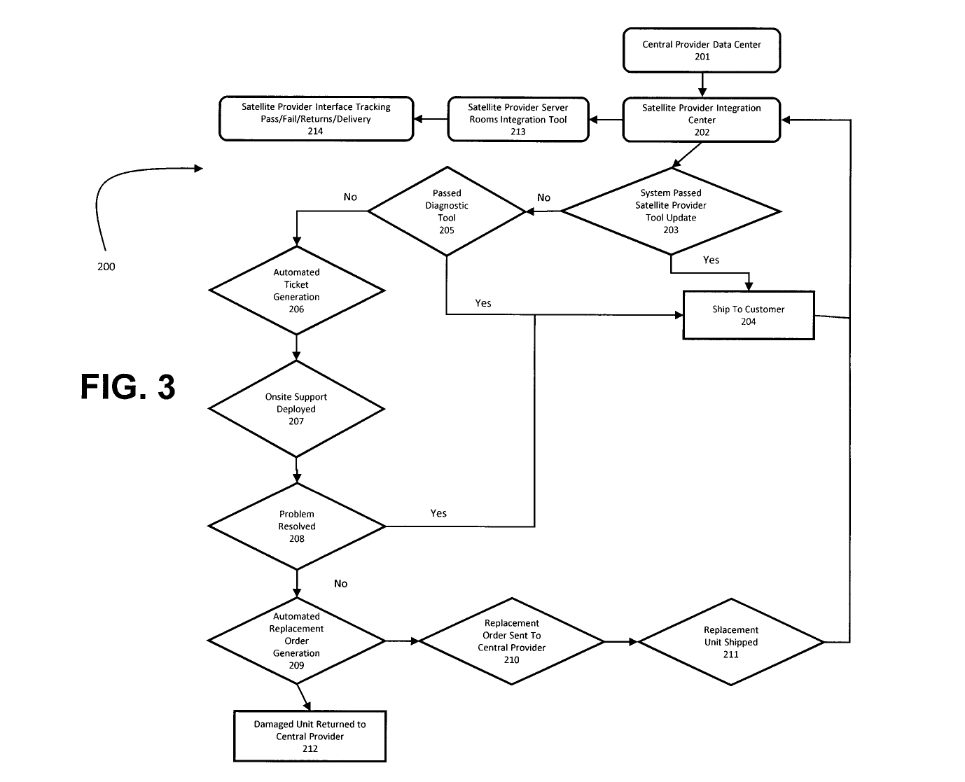

FIG. 3 discloses an exemplary method 200 related to exemplary method 100 according to an aspect of the present invention. Method 200 which may be executed within multiple portions of central system 10 and satellite system 20.

At Step 201, CENTRAL PROVIDER DATA CENTER may provide data, such as software updates, to SATELLITE PROVIDER INTEGRATION CENTER at Step 202. Step 201 may be performed on central server 11 while Step 202 may be performed on satellite server 21.

At Step 203, product systems 23-1, 23-2, 23-3 may be plugged into local connection 22 and Steps 102, 103, 104, 105 from method 100 may be run on product systems 23-1, 23-2, 23-3. For example, software updates may be uploaded from satellite server 21 to product systems 23-1, 23-2, 23-3 and a log may be created on satellite server 21 concerning a specific system of product systems 23-1, 23-2, 23-3 which may then be sent to tracking server 12. If all of Steps 102, 103, 104, 105 run without incident, product systems 23-1, 23-2, 23-3 may be unplugged from local connection 22 and shipped to the end customer in Steps 109, 204.

If a problem is detected at Step 203, however satellite system 20 may proceed to Step 205 where diagnostics may be run and repairs of product systems 23-1, 23-2, 23-3 conducted. Step 205 may incorporate one or more of Steps 106, 107, 108 from method 100. If the repairs are properly conducted in Step 205, product systems 23-1, 23-2, 23-3 may then proceed to Steps 109, 204.

If Step 205 is not successful, however, an automated ticket may be generated at AUTOMATED TICKET GENERATION of Step 206. This ticket may be sent from satellite server 21 to central server 11 and tracking server 12 so as to notify the central provider. The central provider may then dispatch onsite support at ONSITE SUPPORT DEPLOYED at Step 207 so that a specialist may attempt to diagnose and fix the problem. This onsite support may be virtual through a weblink or personal.

If at Step 208 of PROBLEM RESOLVED the problem is resolved, product systems 23-1, 23-2, 23-3 may again proceed to Steps 109, 204 and be shipped to the end customer from the satellite provider.

If at Step 208 of PROBLEM RESOLVED the problem cannot be resolved by the specialist deployed from the central provider, however, Step 209 is invoked for AUTOMATED REPLACEMENT ORDER GENERATION at satellite server 21 and then the REPLACEMENT ORDER SENT TO CENTRAL PROVIDER at Step 210 for replacement product systems 23-1, 23-2, 23-3. This replacement product systems 23-1, 23-2, 23-3 is shipped at Step 211 of REPLACEMENT UNIT SHIPPED and then the method returns to Steps 202, 203 where the replacement product systems 23-1, 23-2, 23-3 uploads software updates and follows the rest of the steps in methods 100, 200.

Also at Step 209, along with REPLACEMENT ORDER GENERATION, the DAMAGED UNIT RETURNED TO CENTRAL PROVIDER is performed at Step 212.

After Steps 109, 204, 211, data concerning product systems 23-1, 23-2, 23-3 that have gone through methods 100, 200, whether shipped to the customer or returned to the provider, is logged on satellite server 21 and then sent to tracking server 12 at Step 213. Accordingly, should it become necessary at a later date to access information concerning a history of product systems 23-1, 23-2, 23-3, for example, to ascertain which software updates were shipped with product systems 23-1, 23-2, 23-3, such information can be accessed at satellite server 21 and tracking server 12 at Step 214.

Any type of relevant data may be stored on any of central server 11, tracking server 12, and satellite server 21. For example, data concerning product systems 23-1, 23-2, 23-3 may include any combination of the software versions and updates installed on product systems 23-1, 23-2, 23-3, any problems on product systems 23-1, 23-2, 23-3 ascertained while running either automatic or manual diagnostics, current physical and supply chain locations of product systems 23-1, 23-2, 23-3, warranty start date information based on when product systems 23-1, 23-2, 23-3 are actually shipped from the satellite provider to the end customer.

Once the satellite provider installs the relevant system on satellite server 21, satellite server 21 automatically downloads any relevant software updates from central server 11 for any software on any product system sold by satellite provider. When the relevant system is installed on satellite server 21, the appropriate settings may be put into place so as to ensure all the proper software updates are provided to satellite server 21. Such settings may be set on either satellite server 21 or central server 11, which may keep a log of what software updates need to be uploaded to satellite server 21. Accordingly, no human resources are necessary on the part of the satellite provider to constantly check with the central provider for software updates.

Once the satellite provider has customized products systems 23-1, 23-2, 23-3 for the appropriate customer, prior to shipping the product to the customer, the satellite provider needs to merely plug products systems 23-1, 23-2, 23-3 into local connection 22. The system installed on satellite server 21 will then automatically update all the software and perform basic tests on products systems 23-1, 23-2, 23-3, such as a power up and power down, to ensure that products systems 23-1, 23-2, 23-3 are in proper working order and include the most updated software. As the only human resources need are to manually plug products systems 23-1, 23-2, 23-3 into local connection 22, little time and effort is wasted on the part of the satellite provider, yet the system is fully tested prior to sending the unit to the customer such that a higher customer satisfaction is obtained.

Results of all the software updates, diagnostics, and tests of products systems 23-1, 23-2, 23-3 are logged in satellite server 21 and then sent to tracking server 12 where the information is stored, for example, in a directory corresponding to products systems 23-1, 23-2, 23-3. Accordingly, should either the satellite provider or a customer report problems with products systems 23-1, 23-2, 23-3, an accurate log of the software updates and any problems previously reported with products systems 23-1, 23-2, 23-3 are available so as to assist the central provider in diagnosing and fixing the problem.

Additionally, the results of all the software updates, diagnostics, and tests of products systems 23-1, 23-2, 23-3 can also be used by the central provider to proactively determine whether there are any systematic problems in the manufacturing process. For example, if a high number of products systems 23-1, 23-2, 23-3 at a particular satellite provider fail the initial test and undergo diagnostics at Steps 106, 205, the central provider can work with the satellite provider to identify and fix the systematic problem that is particular to that satellite provider. As there is real-time communication between central system 10 and satellite system 20, such systematic problems can be quickly detected and resolved. Moreover, such automation saves human resources on the part of the central provider and satellite provider to compile, report, and analyze the data, and also reduces any human biases in the compiling and reporting of data.

As products systems 23-1, 23-2, 23-3 undergo methods 100, 200 prior to shipping and the resulting data is sent back to the central provider at that time, the central provider can keep a more accurate log of where products systems 23-1, 23-2, 23-3 are in the supply chain to the customer. For example, the central provider can reset the warranty date for products systems 23-1, 23-2, 23-3 from the time the central provider sent products systems 23-1, 23-2, 23-3 to the satellite provider to the time the satellite provider sent products systems 23-1, 23-2, 23-3 to the end customer.

Because diagnostics are performed automatically at Steps 106, 205 by a combination of satellite server 21 and central server 11 communicating with each other, it saves the need for someone at the satellite provider to get in touch with someone at the central provider and waste time and resources trying to ascertain the problem.

Furthermore, the AUTOMATED TICKET GENERATION at Step 206 is automatically sent to the central provider by satellite server 21, again obviating the need for someone at the satellite provider to contact someone at the central provider and saving time and resources.

Due to this automation, some of the costs to the central provider and satellite provider that may be reduced include parts pricing, parts distribution, service calls, labor rates for both the central provider and satellite provider, engineering support, critical situational process management, lost revenue, returns processing, additional shipping costs, and travel.

Also due to this automation, the number of things to keep track of and the hassle on the part of the satellite provider and customer are reduced. The central provider also benefits because they will now only be contacted directly for the problems that cannot be diagnosed easily and thus do require human attention. The central provider can also have a log to dispute certain defective returns that are not the fault of either the central provider or the satellite provuder.

Moreover, customer and satellite provider satisfaction will rise as products systems 23-1, 23-2, 23-3 will have the latest updates without any hassle on their part.

Software necessary to run methods 100, 200 may be uploaded on central server 11, tracking server 12, and satellite server 21. Once installed, updates to software necessary to run methods 100, 200 may be automatically uploaded to satellite server 21 from central server 11.

Results from methods 100, 200 concerning product systems 23-1, 23-2, 23-3 may be reported back to tracking server 12 as often as necessary and desired.

While the invention has been described in terms of several exemplary embodiments, those skilled in the art will recognize that the invention can be practiced with modification within the spirit and scope of the appended claims. Further, it is noted that, Applicant's intent is to encompass equivalents of all claim elements, even if amended later during prosecution.

1. A method of integrating a central system and a satellite system for automatically updating software and providing diagnostics for a product system to be shipped to an end customer, comprising:
providing the central system including a central server and a tracking server at a central provider location;
providing a satellite system including a satellite server and a local connection at a satellite provider location different from the central provider location;
connecting a product system to the local connection;
uploading software updates from the satellite server to the product system;
performing a test boot-up of the product system;
running a system diagnostic if there is a problem with the test boot-up of the product system;
conducting a system repair based on results of the system diagnostic;
generating an automated repair ticket concerning the problem if the system repair is unsuccessful;
reporting the automated repair ticket to the central server;
deploying onsite support to the satellite provider location based on the automated repair ticket;
generating an automated replacement order if the onsite support cannot resolve the problem;
sending the automated replacement order to the central server;
shipping a replacement product system to the satellite provider location based on the automated replacement order;
creating a log on the satellite server of the software updates, results of the system diagnostic, results of the system repair for the product system, the automatic repair ticket, and the automated replacement order;
creating a copy of the log on the tracking server; and
shipping the product system to the end customer.
